(19) United States
(12) Patent Application Publication
(10) Pub. No.: US 2008/0302216 A1
(43) Pub. Date: Dec. 11, 2008

(54) Wrench Socket with Easily Recognizable Size Indicia

(76) Inventor: Bobby Hu, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/117,777

(22) Filed: May 9, 2008

(30) Foreign Application Priority Data
Jun. 8, 2007 (TW) 96120940
Jan. 30, 2008 (TW) 97103547

(51) Int. Cl. B25B 13/06

(52) U.S. Cl. 81/121.1

(57) ABSTRACT

A wrench socket includes first and second ends spaced along a longitudinal axis. The first end includes a recessed indicia area formed in an outer peripheral wall face of a peripheral wall thereof. Size indicia extends outward from a bottom wall of the recessed indicia area and is integrally formed from a single homogenous material with the peripheral wall as a single continuous monolithic piece. The size indicia has a top face extending not beyond the outer peripheral wall face. The radii of the bottom wall and the top face are larger than a radius from the longitudinal axis to the outer peripheral wall face. Centers of curvatures of the bottom wall and the top face are located outside the longitudinal axis.

### BACKGROUND OF THE INVENTION

The present invention relates to a wrench socket and, more particularly, to a wrench socket having size indicia that is easy to recognize and less likely to be damaged.

U.S. Pat. Nos. 4,836,059 and 4,947,713 both to Arnold disclose an elastomeric sleeve mounted to a rear portion of a wrench socket. The elastomeric sleeve is integrally molded from a suitable plastic, rubber or other elastomeric material. The elastomeric sleeve is provided with suitable size indicia formed by integral casting or molding. A suitable adhesive secures the sleeve on the socket and precludes an axial separation therebetween. In another embodiment disclosed in U.S. Pat. No. 4,836,059, a pressure-sensitive laminated label is bonded to the sleeve and includes size indicia formed by impression stamping, printing, engraving or other methods. However, the size indicia is not directly formed on the sleeve and involves complicated manufacturing procedures, leading to waste of time and costs. Furthermore, the size indicia is liable to become indistinct due to impact or abrasion.

U.S. Design Pat. No. 442,837 to Porras discloses a grippable drive socket having knurls on an outer periphery thereof and size indicia formed in the outer periphery by rolling. U.S. Pat. No. 6,761,093 to Chang and U.S. Patent Publication No. 2006/0090612 A1 also disclose socket having size indicia formed on the outer periphery by rolling. However, the distance from the size indicia to the outer periphery of the socket must be limited to avoid damage to the structural strength and/or mechanical properties of the hollow socket formed by rolling. As a result, the size indicia is liable to be damaged due to impact or abrasion.

U.S. Pat. No. 7,028,588 to Shih discloses a tool including a rectangular area formed on a cylindrical outer surface thereof. An identification mark or numeral is formed on the rectangular area as a representation of a size of the tool. The rectangular area and the numeral have different colors. The numeral is formed by cutting through the rectangular area to form a stencil for exposing a metal color of the tool and providing a contrast of the numeral to other portions of the area. Deformation of the tool resulting from stamping is avoided. However, formation of the numeral by cutting to form a stencil is much complicated and expensive. Furthermore, the numeral thus formed has a film-like structure that is liable to be damaged or become blurred due to impact or abrasion.

A need exists for a wrench socket with size indicia that is more resistant to impact and/or abrasion and that is easy to recognize.

### BRIEF SUMMARY OF THE INVENTION

The present invention solves this need and other problems in the field of wrench sockets by providing, in a preferred form, a wrench socket including first and second ends spaced along a longitudinal axis. The second end is adapted for driving a fastener. The first end includes a peripheral wall having an outer peripheral wall face and an inner peripheral wall face. The inner peripheral wall defines an engaging hole adapted for coupling with a wrench. The peripheral wall is made of a single homogenous material. The outer peripheral wall face has a first radius from the longitudinal axis. The first end further includes a recessed indicia area formed in the outer peripheral wall face. The recessed indicia area includes a bottom wall spaced from the longitudinal axis in a radial direction perpendicular to the longitudinal axis. The bottom wall has a second radius larger than the first radius and, most preferably, not less than 1.5 times the first radius. The bottom wall further has a first center of curvature located outside the longitudinal axis. Size indicia extends outward from the bottom wall of the recessed indicia area and is integrally formed from the single homogenous material with the peripheral wall as a single continuous monolithic piece. The size indicia has a top face spaced from the bottom wall in the radial direction and extending not beyond the outer peripheral wall face. The top face has a third radius larger than the first radius and, most preferably, not less than 1.5 times the first radius. The top face further has a second center of curvature located outside the longitudinal axis.

In a most preferred form, the top face of the size indicia and the bottom wall of the recessed indicia area are convex. The first center of curvature is spaced from the second center of curvature. In an example, both the first and second centers of curvatures are located inside the peripheral wall or outside the first end. The second radius is equal to the third radius. In another example, one of the first and second centers of curvatures is located inside the peripheral wall, and the other of the first and second centers of curvatures is located outside the first end. Furthermore, the second radius is not equal to the third radius.

In another most preferred form, the top face of the size indicia and the bottom wall of the recessed indicia area are planar and parallel to and spaced from the longitudinal axis. The bottom wall includes parallel, spaced first and second edges and parallel, spaced third and fourth edges extending between and orthogonal to the first and second edges. The first and second edges are on the outer peripheral wall face of the first end. The recessed indicia area further includes first and second interconnecting faces extending from the third and fourth edges to the outer peripheral wall face and at an angle with the bottom wall. The size indicia is spaced from the first, second, third, and fourth edges.

In a further most preferred form, the top face of the size indicia and the bottom wall of the recessed indicia area are concave. The first and second centers of curvatures are located outside the first end and spaced from each other. The bottom wall includes parallel, spaced first and second edges and parallel, spaced third and fourth edges extending between and orthogonal to the first and second edges. The first and second edges are on the outer peripheral wall face of the first end. The recessed indicia area further includes first and second interconnecting faces extending from the third and fourth edges to the outer peripheral wall face and at an angle with the bottom wall. The size indicia is spaced from the first, second, third, and fourth edges.

Damage to the size indicia of the socket wrench according to the preferred teachings of the present invention is less likely to occur, for the top face of the size indicia does not extend beyond the outer peripheral wall face and for the size indicia is integrally formed from a single homogenous material with the peripheral wall as a single continuous monolithic piece. Furthermore, the arrangement of the bottom wall of the recessed indicia area and the top face of the size indicia provide easily recognizable size indicia for users.

The present invention will become clearer in light of the following detailed description of illustrative embodiments of this invention described in connection with the drawings.

### DESCRIPTION OF THE DRAWINGS

The illustrative embodiments may best be described by reference to the 8 accompanying drawings where:

FIG. 1 shows a perspective view of a wrench socket of a first embodiment according to the preferred teachings of the present invention.

FIG. 2 shows a cross-sectional view of the wrench socket of FIG. 1 according to section line 2-2 of FIG. 1.

FIG. 3 shows a side elevational view of a wrench socket of a second embodiment according to the preferred teachings of the present invention.

FIG. 4 shows a side elevational view of a wrench socket of a third embodiment according to the preferred teachings of the present invention.

FIG. 5 shows a side elevational view of a wrench socket of a fourth embodiment according to the preferred teachings of the present invention.

FIG. 6 shows a side elevational view of a wrench socket of a fifth embodiment according to the preferred teachings of the present invention.

FIG. 7 shows a perspective view of a wrench socket of a sixth embodiment according to the preferred teachings of the present invention.

FIG. 8 shows a cross-sectional view of the wrench socket of FIG. 7 according to section line 8-8 of FIG. 7.

FIG. 9 shows a perspective view of a wrench socket of a seventh embodiment according to the preferred teachings of the present invention.

FIG. 10 shows a cross-sectional view of the wrench socket of FIG. 9 according to section line 10-10 of FIG. 9.

FIG. 11 shows a cross-sectional view of a wrench socket of an eighth embodiment according to the preferred teachings of the present invention.

FIG. 12 shows a cross-sectional view of a wrench socket of a ninth embodiment according to the preferred teachings of the present invention.

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “end”, “area”, “section”, “radial”, “outward”, “peripheral”, “depth”, “length”, “diameter”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

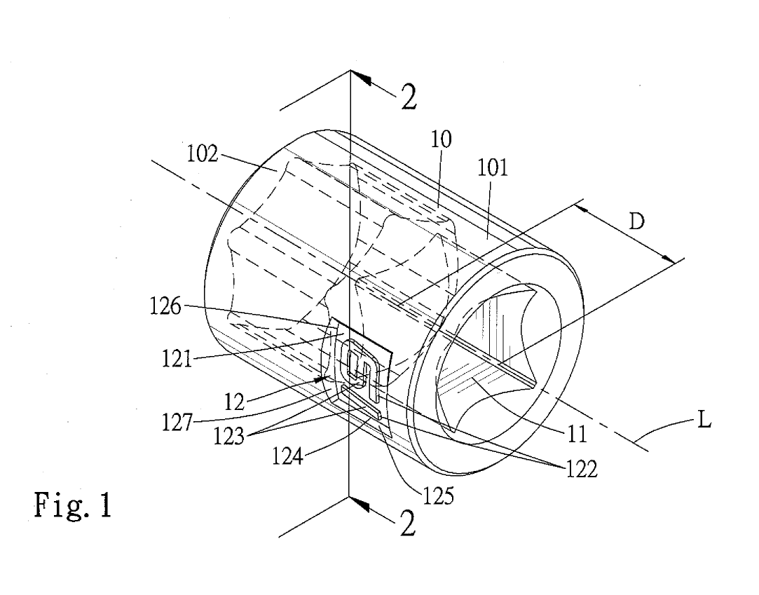

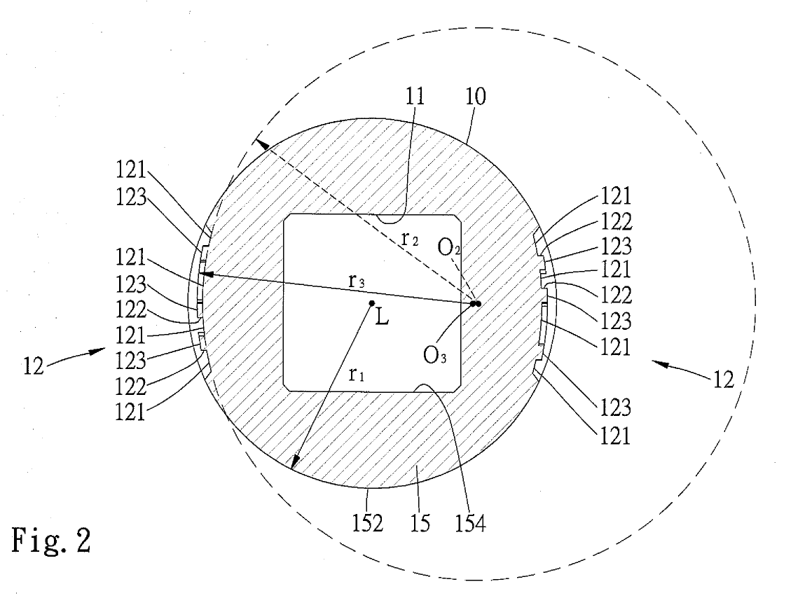

A wrench socket of a first embodiment according to the preferred teachings of the present invention is shown in FIGS. 1 and 2 and designated 10. According to the preferred fomm shown, socket 10 includes first and second ends 101 and 102 spaced along a longitudinal axis L and having an identical outer diameter. Second end 102 can be coupled with and drive an object such as a bolt, nut, or the like. First end 101 includes a peripheral wall 15 made of a single homogenous material and having an outer peripheral wall face 152 and an inner peripheral wall face 154. Inner peripheral wall 154 defines an engaging hole 11 having a depth D along longitudinal axis L. Engaging hole 11 can be coupled with a socket wrench or the like for driving socket 10. Outer peripheral wall face 152 has a first radius r1 from longitudinal axis L. First end 101 further includes two diametrically opposed recessed indicia areas 12 formed in outer peripheral wall face 152. A length of each recessed indicia area 12 along longitudinal axis L is less than depth D. Each recessed indicia area 12 has a convex bottom wall 121 spaced from longitudinal axis L in a radial direction perpendicular to longitudinal axis L. Bottom wall 121 of each recessed indicia area 12 has a second radius r2 larger than first radius r1 and, most preferably, not less than 1.5 times first radius r1. Bottom wall 121 of each recessed indicia area 12 further has a first center of curvature O2 located outside longitudinal axis L and inside peripheral wall 15. Bottom wall 121 of each recessed indicia area 12 includes parallel, spaced first and second edges 124 and parallel, spaced third and fourth edges 126 extending between and orthogonal to first and second edges 124. Each recessed indicia area 12 further includes first and second interconnecting faces 125 extending from first and second edges 124 to outer peripheral wall face 152 and at an angle with bottom wall 121. Recessed indicia area 12 further includes third and fourth interconnecting faces 127 extending from third and fourth edges 126 to outer peripheral wall face 152 and at an angle with bottom wall 121.

According to the preferred form shown, each recessed indicia area 12 further includes size indicia 122 extending outward from bottom wall 121 and spaced from first, second, third, and fourth edges 124 and 126. Each size indicia 122 is integrally formed from the single homogenous material with peripheral wall 15 as a single continuous monolithic piece. Furthermore, each size indicia 122 includes a convex top face 123 spaced from bottom wall 121 in the radial direction and not beyond outer peripheral wall face 152. Top face 123 of each size indicia 122 has a third radius r3 larger than first radius r1 and, most preferably, not less than 1.5 times first radius r1. Top face 123 further has a second center of curvature O3 located outside the longitudinal axis L and inside peripheral wall 15. According to the preferred form shown, second radius r2 is equal to third radius r3, and first center of curvature O2 is spaced from second center of curvature O3. Since each size indicia 122 is below outer peripheral wall face 152 and since each size indicia 122 is integrally formed from a single homogenous material with peripheral wall 15 as a single continuous monolithic piece, damage to each size indicia 122 is less likely to occur. Furthermore, convex bottom wall 121 of each recessed indicia area 12 and convex top face 123 of each size indicia 122 provide easily recognizable size indicia 122 for users.

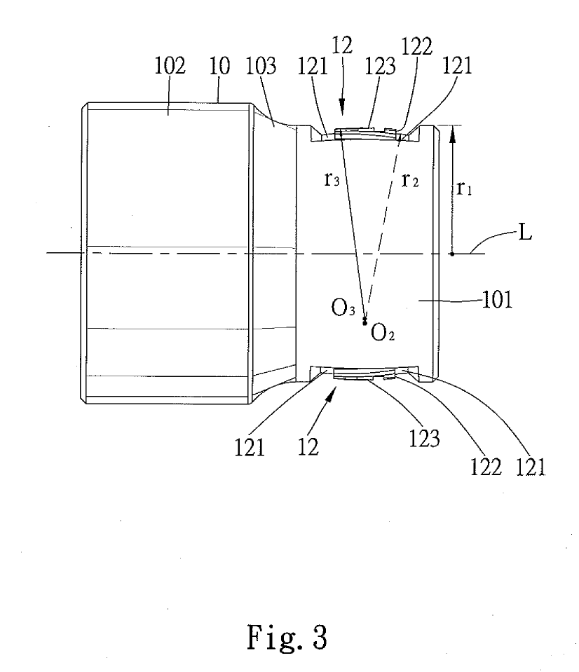

FIG. 3 shows a second embodiment according to the preferred teachings of the present invention modified from the first embodiment. In this embodiment, socket 10 further includes a shoulder 103 between first and second ends 101 and 102. Further, second end 102 has an outer diameter larger than that of first end 101.

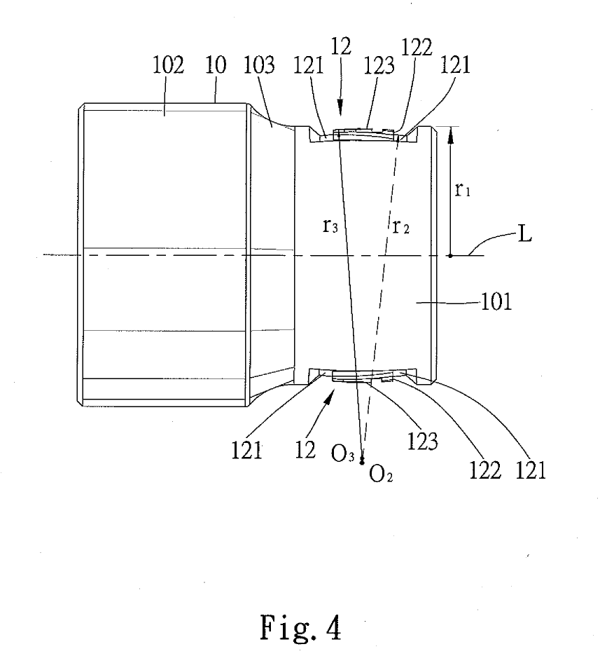

FIG. 4 shows a third embodiment according to the preferred teachings of the present invention modified from the embodiment of FIG. 3. In this embodiment, first center of curvature O2 of bottom wall 121 of each recessed indicia area 12 is located outside peripheral wall 15 and outside first end 101. Furthermore, second center of curvature O3 of top face 123 of each size indicia 122 is located outside peripheral wall 15 and outside first end 101 and spaced from first center of curvature O2. Further, second radius r2 is equal to third radius r3.

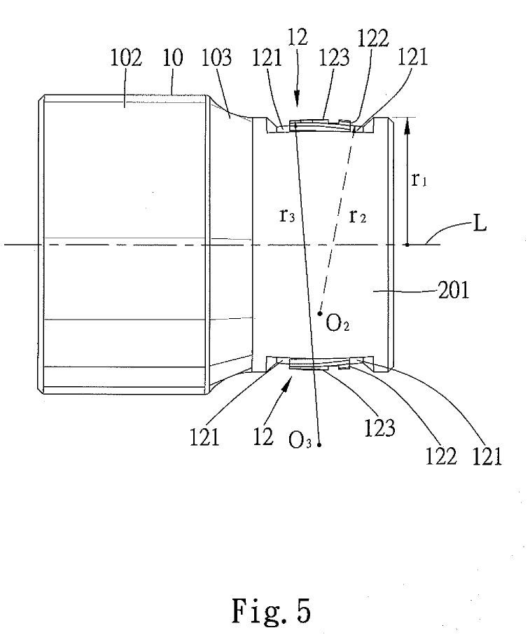

FIG. 5 shows a fourth embodiment according to the preferred teachings. of the present invention modified from the embodiment of FIG. 3, wherein first center of curvature O2 of bottom wall 121 of each recessed indicia area 12 is located inside peripheral wall 15. Furthermore, second center of curvature O3 of top face 123 of each size indicia 122 is located outside peripheral wall 15 and outside first end 101 and spaced from first center of curvature O2. Further, second radius r2 is less than third radius r3.

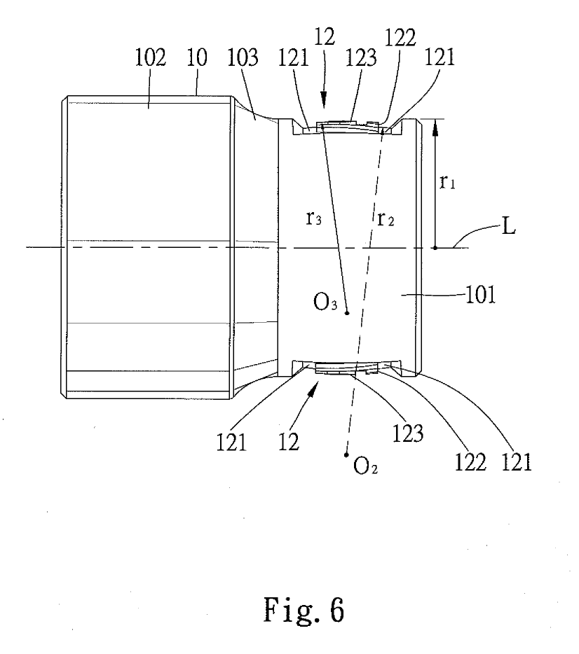

FIG. 6 shows a wrench socket 10 according to a fifth embodiment according to the preferred teachings of the present invention modified from the embodiment of FIG. 3, wherein first center of curvature O2 of bottom wall 121 of each recessed indicia area 12 is located outside peripheral wall 15 and outside first end 101. Furthermore, second center of curvature O3 of top face 123 of each size indicia 122 is located inside peripheral wall 15 and spaced from first center of curvature O2. Further, second radius r2 is larger than third radius r3.

In the embodiments of FIGS. 3 through 6, since each size indicia 122 is below outer peripheral wall face 152 and since each size 122 indicia is integrally formed from a single homogenous material with peripheral wall 15 as a single continuous monolithic piece, damage to each size indicia 122 is less likely to occur. Furthermore, convex bottom wall 121 of each recessed indicia area 12 and convex top face 123 of each size indicia 122 provide easily recognizable size indicia 122 for users.

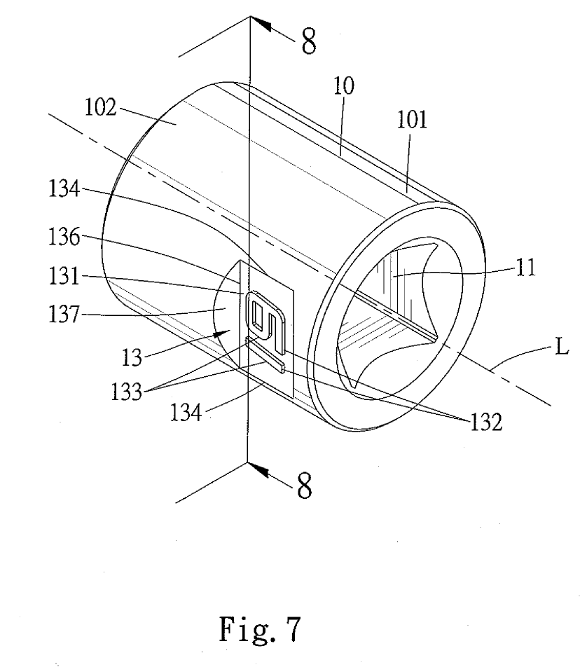

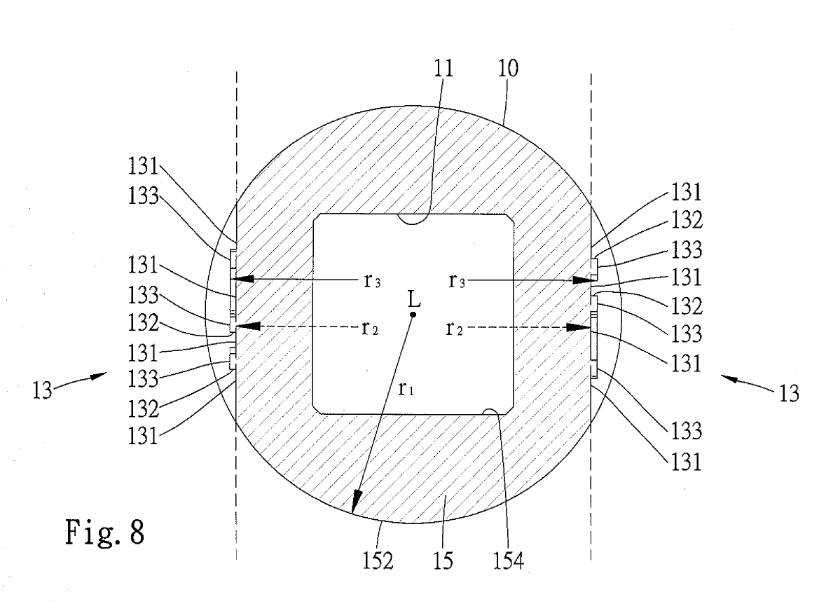

FIGS. 7 and 8 show a wrench socket 10 according to a sixth embodiment according to the preferred teachings of the present invention. According to the preferred form shown, socket 10 includes first and second ends 101 and 102 spaced along a longitudinal axis L. Second end 102 can be coupled with and drive an object such as a bolt, nut, or the like. First end 101 includes a peripheral wall 15 made of a single homogenous material and having an outer peripheral wall face 152 and an inner peripheral wall face 154. Inner peripheral wall 154 defines an engaging hole 11 that can be coupled with a socket wrench or the like for driving socket 10. Outer peripheral wall face 152 has a first radius r1 from longitudinal axis L. First end 101 further includes two diametrically opposed recessed indicia areas 13 formed in the outer peripheral wall face 152. Each recessed indicia area 13 has a bottom wall 131 spaced from longitudinal axis L in a radial direction perpendicular to longitudinal axis L. Bottom wall 131 of each recessed indicia area 13 is planar and parallel to and spaced from the longitudinal axis L and has a second radius r2 that is infinitely large. Namely, the center of curvature of bottom wall 131 of each recessed indicia area 13 is outside first end 101. Bottom wall 131 includes parallel, spaced first and second edges 134 and parallel, spaced third and fourth edges 136 extending between and orthogonal to the first and second edges 134. First and second edges 134 are on outer peripheral wall face 152 of first end 101. Each recessed indicia area 13 further includes first and second interconnecting faces 137 extending from third and fourth edges 136 to outer peripheral wall face 152 and at an angle with bottom wall 131.

According to the preferred form shown, each recessed indicia area 13 further includes size indicia 132 extending outward from bottom wall 131 of and spaced from first, second, third, and fourth edges 134 and 136. Each size indicia 132 is integrally formed from the single homogenous material with peripheral wall 15 as a single continuous monolithic piece. Furthermore, each size indicia 132 includes a top face 133 spaced from bottom wall 131 in the radial direction and not beyond outer peripheral wall face 152. Top face 133 of each size indicia 13 is planar and parallel to and spaced from the longitudinal axis L and has a third radius r3 that is infinitely large. Note that the center of curvature of bottom wall 131 is outside first end 101 and that second radius r2 is equal to third radius r3. Since each size indicia 132 is below outer peripheral wall face 152 and since each size indicia 132 is integrally formed from a single homogenous material with peripheral wall 15 as a single continuous monolithic piece, damage to each size indicia 132 is less likely to occur. Furthermore, planar bottom wall 131 of each recessed indicia area 13 and planar top face 133 of each size indicia 132 provide easily recognizable size indicia 132 for the users.

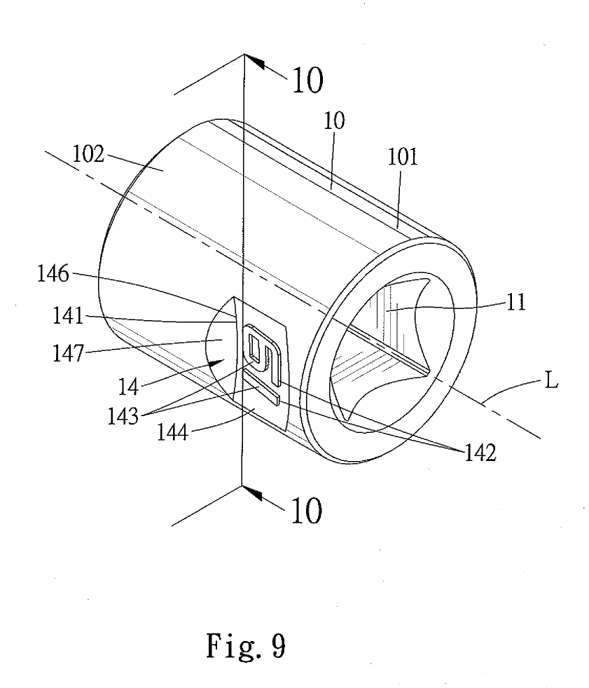

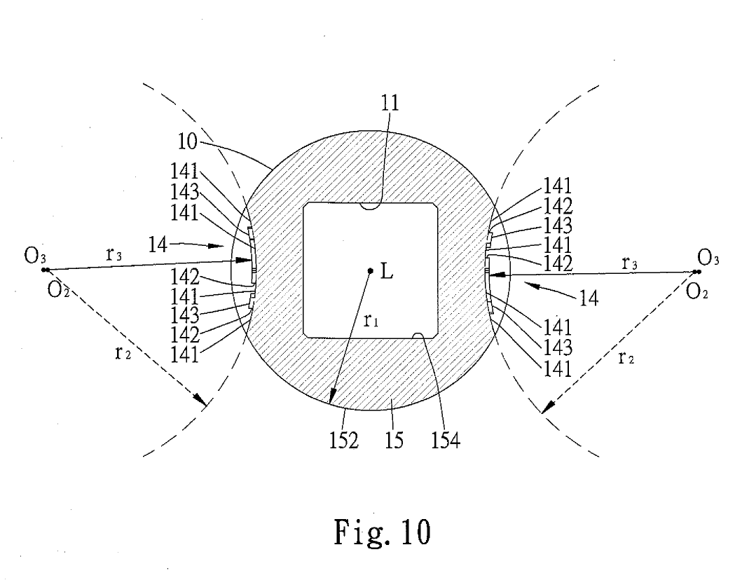

FIGS. 9 and 10 show a wrench socket 10 according to a seventh embodiment according to the preferred teachings of the present invention. According to the preferred form shown, socket 10 includes first and second ends 101 and 102 spaced along a longitudinal axis L. Second end 102 can be coupled with and drive an object such as a bolt, nut, or the like. First end 101 includes a peripheral wall 15 made of a single homogenous material and having an outer peripheral wall face 152 and an inner peripheral wall face 154. Inner peripheral wall 154 defines an engaging hole 11 that can be coupled with a socket wrench or the like for driving socket 10. Outer peripheral wall face 152 has a first radius r1 from longitudinal axis L. Outer peripheral wall face 152 includes two diametrically opposed recessed indicia areas 14 formed in the outer peripheral wall face 152. Each recessed indicia area 14 has a concave bottom wall 141 spaced from longitudinal axis L in a radial direction perpendicular to longitudinal axis L. Bottom wall 141 of each recessed indicia area 14 has a second radius r2 larger than first radius r1 and, most preferably, not less than 1.5 times first radius r1. Bottom wall 141 further has a first center of curvature O2 located outside peripheral wall 15 and outside first end 101. Bottom wall 141 of each recessed indicia area 14 includes parallel, spaced first and second edges 144 and parallel, spaced third and fourth edges 146 extending between and orthogonal to the first and second edges 144. First and second edges 144 are on outer peripheral wall face 152 of first end 101. Each recessed indicia area 14 further includes first and second interconnecting faces 147 extending from third and fourth edges 146 to outer peripheral wall face 152 and at an angle with bottom wall 141.

According to the preferred form shown, each recessed indicia area 14 further includes size indicia 142 extending outward from bottom wall 141 and spaced from first, second, third, and fourth edges 144 and 146. Each size indicia 142 is integrally formed from the single homogenous material with peripheral wall 15 as a single continuous monolithic piece. Furthermore, size indicia 142 includes a top face 143 spaced from bottom wall 141 in the radial direction and not beyond outer peripheral wall face 142. Top face 143 of each size indicia 142 has a third radius r3 larger than first radius r1 and, most preferably, not less than 1.5 times first radius r1. Top face 143 of each size indicia 142 further has a second center of curvature O3 located outside peripheral wall 15 and outside first end 101 and spaced from first center of curvature O2. Further, second radius r2 is equal to third radius r3.

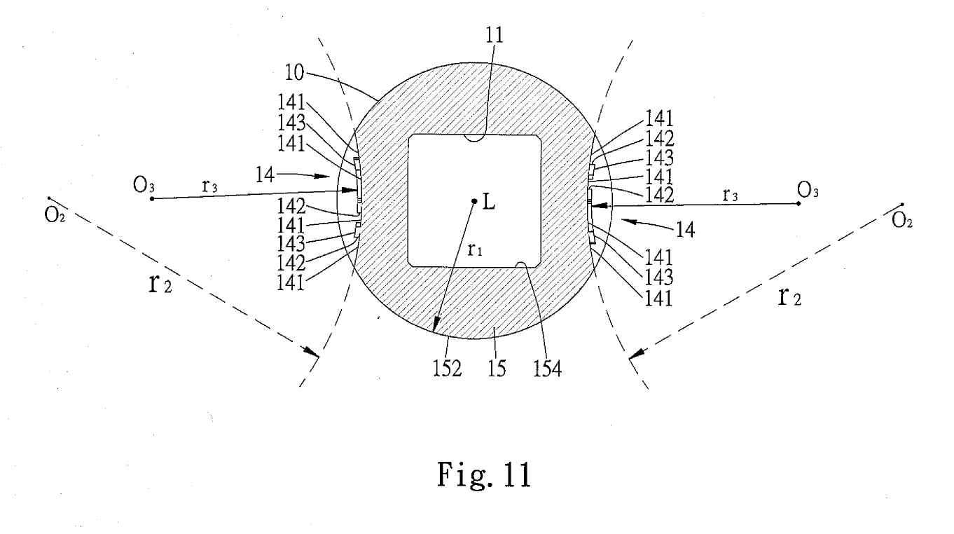

FIG. 11 shows an eighth embodiment according to the preferred teachings of the present invention modified from the embodiment of FIG. 10, wherein second radius r2 is larger than third radius r3.

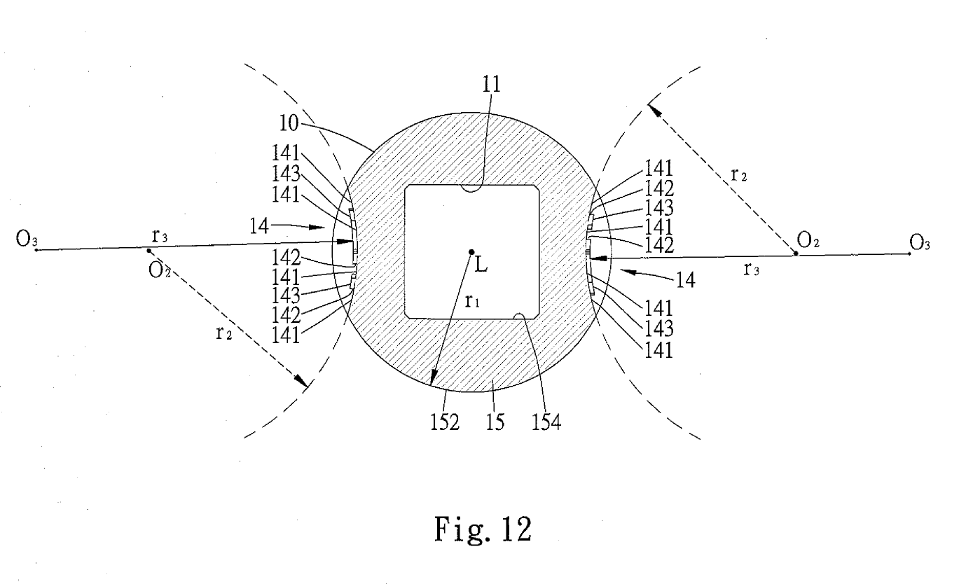

FIG. 12 shows an eighth embodiment according to the preferred teachings of the present invention modified from the embodiment of FIG. 10, wherein the second radius r2 is less than third radius r3.

In the embodiments of FIGS. 9 through 12, since each size indicia 142 is below outer peripheral wall face 152 and since each size indicia 142 is integrally formed from a single homogenous material with peripheral wall 15 as a single continuous monolithic piece, damage to each size indicia 142 is less likely to occur. Furthermore, concave bottom wall 141 of each recessed indicia area 14 and concave top face 143 of each size indicia 142 provide easily recognizable size indicia 142 for the users.

Now that the basic teachings of the present invention have been explained, many extensions and variations will be obvious to one having ordinary skill in the art. For example, shoulder 103 of wrench sockets 10 of FIGS. 4 through 6 can be omitted, and first and second ends 101 and 102 can have identical outer diameter. Furthermore, wrench sockets 10 of FIGS. 9 through 12 can have first and second ends 101 and 102 of different outer diameters and a shoulder between first and second ends 101 and 102. Furthermore, fewer or more number of recessed indicia areas 12, 13, 14 and size indicia 122, 132, 142 can be formed on wrench socket 10 according to the preferred teachings of the present invention. As an example, first end 101 can include only one recessed indicia area 12, 13, 14. However, first end 101 can include three or more annularly spaced recessed indicia areas 12, 13, 14.

It can be appreciated that wrench sockets 10 according to the preferred teachings of the present invention can be manufactured at costs lower than conventional sockets and by suitable methods less complicated than those for conventional sockets. As an example, wrench sockets 10 according to the preferred teachings of the present invention can be made by methods disclosed in U.S. patent application Ser. No. 11/946,075 filed on Nov. 28, 2007, the entire contents of which are incorporated herein by reference.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A wrench socket comprising:
first and second ends spaced along a longitudinal axis, with the second end being adapted for driving a fastener, with the first end including a peripheral wall having an outer peripheral wall face and an inner peripheral wall face, with the inner peripheral wall defining an engaging hole adapted for coupling with a wrench, with the peripheral wall being made of a single homogenous material, with the outer peripheral wall face having a first radius from the longitudinal axis, with the first end further including a recessed indicia area formed in the outer peripheral wall face, with the recessed indicia area including a bottom wall spaced from the longitudinal axis in a radial direction perpendicular to the longitudinal axis, with the bottom wall having a second radius larger than the first radius and a first center of curvature located outside the longitudinal axis; and
size indicia extending outward from the bottom wall of the recessed indicia area, with the size indicia being integrally formed from the single homogenous material with the peripheral wall as a single continuous monolithic piece, with the size indicia having a top face spaced from the bottom wall in the radial direction, with the top face extending not beyond the outer peripheral wall face, with the top face having a third radius larger than the first radius and a second center of curvature located outside the longitudinal axis.

2. The wrench socket as claimed in claim 1, with the top face of the size indicia and the bottom wall of the recessed indicia area being convex, with the first center of curvature being spaced from the second center of curvature, with the second radius being not less than 1.5 times the first radius, and with the third radius being not less than 1.5 times the first radius.

3. The wrench as claimed in claim 2, with the first and second centers of curvatures being located inside the peripheral wall.

4. The wrench socket as claimed in claim 3, with the second radius being equal to the third radius.

5. The wrench socket as claimed in claim 2, with the first and second centers of curvatures being located outside the peripheral wall and outside the first end.

6. The wrench socket as claimed in claim 5, with the second radius being equal to the third radius.

7. The wrench socket as claimed in claim 2, with the first center of curvature being located inside the peripheral wall, with the second center of curvature being located outside the peripheral wall and outside the first end, and with the third radius being larger than the second radius.

8. The wrench socket as claimed in claim 2, with the second center of curvature being located inside the peripheral wall, with the first center of curvature being located outside the peripheral wall and outside the first end, and with the third radius being less than the second radius.

9. The wrench socket as claimed in claim 1, with the top face of the size indicia and the bottom wall of the recessed indicia area being planar and parallel to and spaced from the longitudinal axis, with the bottom wall including parallel, spaced first and second edges and parallel, spaced third and fourth edges extending between and orthogonal to the first and second edges, with the first and second edges being on the outer peripheral wall face of the first end, with the recessed indicia area further including first and second interconnecting faces extending from the third and fourth edges to the outer peripheral wall face and at an angle with the bottom wall, and with the size indicia being spaced from the first, second, third, and fourth edges.

10. The wrench socket as claimed in claim 1, with the top face of the size indicia and the bottom wall of the recessed indicia area being concave, with the first and second centers of curvatures being located outside the peripheral wall and outside the first end and spaced from each other, with the second radius being not less than 1.5 times the first radius, and with the third radius being not less than 1.5 times the first radius.

11. The wrench socket as claimed in claim 10, with the bottom wall including parallel, spaced first and second edges and parallel, spaced third and fourth edges extending between and orthogonal to the first and second edges, with the first and second edges being on the outer peripheral wall face of the first end, with the recessed indicia area further including first and second interconnecting faces extending from the third and fourth edges to the outer peripheral wall face and at an angle with the bottom wall, and with the size indicia being spaced from the first, second, third, and fourth edges.

12. The wrench socket as claimed in claim 11, with the second radius being equal to the third radius.

13. The wrench socket as claimed in claim 1, with the second radius being larger than the third radius.

14. The wrench socket as claimed in claim 11, with the second radius being less than the third radius.

15. The wrench socket as claimed in claim 1, with the first center of curvature being located inside the peripheral wall, and with the second center of curvature being located outside the peripheral wall and outside the first end.

16. The wrench socket as claimed in claim 1, with the second center of curvature being located inside the peripheral wall, and with the first center of curvature being located outside the peripheral wall and outside the first end.

17. The wrench socket as claimed in claim 1, with the first and second centers of curvatures being located inside the peripheral wall.

18. The wrench socket as claimed in claim 1, with the first and second centers of curvatures being located outside the peripheral wall and outside the first end.
